(19) United States
(12) Patent Application Publication
(10) Pub. No.: US 2025/0128489 A1
(43) Pub. Date: Apr. 24, 2025

(54) APPARATUS FOR SUBDIVIDING AS BRIQUETTE STRAND

(71) Applicant: MASCHINENFABRIK KÖPPERN GMBH & CO. KG, Hattingen (DE)

(72) Inventors: Eggert DE WELDIGE, Velbert Langenberg (DE); Ralf KLUSE, Hattingen (DE)

(21) Appl. No.: 18/728,539

(22) PCT Filed: Jan. 20, 2023
(86) PCT No.: PCT/EP2023/051391

§ 371 Date: Jul. 12, 2024

(30) Foreign Application Priority Data
Jan. 21, 2022 (DE) 10 2022 101 419.3

(51) Int. Cl. B30B 15/00; C21B 13/00

(52) U.S. Cl. CPC B30B 15/0005; C21B 13/004

(57) ABSTRACT

The invention relates to an apparatus (6) for dividing a briquette string (5) which has a plurality of contiguous briquette rows (5a) that are arranged one behind the other (in a longitudinal direction (L)) and each comprise, adjacent to one another, a plurality of briquettes (7) connected by material webs (8a, 8b), in particular for manufacturing briquettes (7) from direct reduced iron, said apparatus comprising: a movable beater device (9) which has a plurality of beaters (13) arranged adjacent to one another; and a feed device (10) via which the briquette string (5) can be fed to the beater device (9) in a transport direction (T), the beater device (9) striking the briquette string (5) fed by the feed device (10) with the beaters (13) in such a way that firstly a briquette row (5a) is knocked off the briquette string (5), and secondly the briquette row (5a) is divided into the individual briquettes (7). The apparatus is characterised in that: the beater device (9) and the feed device (10) are designed to divide a briquette string (5) having briquette rows (5a) which each have at least three briquettes (7) arranged adjacent to one another, and the beater device (9) has at least three beaters (13) arranged adjacent to one another. According to the invention, the feed device has at least two mutually spaced noses adjacent to one another, at least one of these noses being designed and/or oriented in such a way that a distance, which widens in the working direction and over which the divided briquettes are discharged, is formed between this nose and the nose located next to it.

The invention relates to an apparatus for subdividing a briquette strand holding, relative to a longitudinal transport direction, a succession of transverse rows of briquettes next to one another and connected together via material webs, in particular for the production of briquettes from directly reduced iron, the apparatus having
a movable beater assembly that has a plurality of beater teeth next to one another;
a feeder that supplies the briquette strand to the beater assembly in a transport direction such that the beater teeth of the beater assembly strike the briquette strand supplied by the feeder such that on the one hand a briquette row is struck off the briquette strand and on the other hand the struck-off briquette row/rows is/are subdivided into individual briquettes.

In addition, the invention relates to a plant for making briquettes, in particular a plant for hot briquetting (e.g. of directly reduced iron), with a briquetting press that continuously produces the briquette strand and an apparatus downstream of the briquetting press that subdivides the briquette strand emerging from the briquetting press. This apparatus for subdividing the briquette strand is also referred to as briquette separator or as briquette strand separator.

The apparatus or the plant preferably is for the production of briquettes from directly reduced iron or DRI (“directly reduced iron”), which is also called sponge iron or iron sponge. The briquettes are also termed hot-briquetted iron (HBI). The starting material is produced by direct reduction of iron ore that is used to produce the briquettes, and indeed preferably in one or in several briquetting presses for hot briquetting. Such briquetting presses are e.g. roller presses that e.g. have two counter-rotating press rollers, whose outer roller surfaces are provided with mold recesses or shaping recesses, so that as the material passes through the roller gap formed between the briquetting rollers a briquette strand is formed with a plurality of columns of briquettes next to each other and extending in the transport direction and consequently in the strand longitudinal direction and a plurality of transverse rows of the briquettes one after the other in the transport direction, and the briquettes in the columns and rows are connected together by material webs. To separate the briquette strand held together by via the material webs after the pressing process, the briquetting press is followed by the apparatus for separating the briquette strand as a “separating apparatus.” This separating apparatus, which is also referred to as a separator, is the basis of the invention.

The apparatus for subdividing the briquette strand has at least a beater assembly with the beater teeth on a for example rotationally driven beater drum that has an outer surface provided with a plurality of transverse rows of beater teeth next to one another. Furthermore the apparatus has a feeder supplying the briquette strand into the area of the beater assembly, such a feeder for example being a feed chute or feed slide or being constructed such that the briquette strand passes by gravity from the briquetting press into the area of the beater assembly. The feeder (e.g. the chute) has at its outlet end an impact edge running transversely to the transport direction of the briquettes, so that in the course of the movement of the beater teeth in the direction these teeth strike off the leading row of briquettes (i.e. a briquette bar). In addition, at least one lug is on or in the area of the feeder, e.g. at or below of the impact edge, so as to separate each struck-off row into individual briquettes.

The feeder can in addition be equipped with an additional hold down that presses the briquette strand fed from the briquetting press down onto the feed chute or feed slide and thus prevents deviation or doubling of the strand.

In practice in the briquetting presses (for hot briquetting) as a rule surface tools with two adjacent cavities are used so that a briquette strand with two briquettes next to each other briquettes is produced, i.e. the individual briquette rows each have two individual briquettes that are connected to each other via a material web. The separation of such a briquette strand takes place with a separator of the type described, where there is in practice below the impact edge a single lug for cutting apart the two briquettes of the briquette row.

Overall the components of such a system and of such an apparatus for subdividing the briquette strand are subject to high loads. In the case of hot briquetting, the components must withstand high temperatures since the hot briquetting takes place, for example, at temperatures between 250° C. and 750° C.

A system for making briquettes with an apparatus for subdividing a briquette strand of the type described above is known for example from of WO 1995/09080 [U.S. Pat. No. 5,666,638] and WO 1995/09079 [U.S. Pat. No. 5,630,202]. The beater assembly of the briquette strand splitter is a beater drum that interacts in the described manner with a feeder a chute or guide rail. The briquette strand fed from the press consists of two adjacent briquette columns so each individual, struck-off briquette row consists of two adjacent briquettes. In order to separate such a struck-off briquette row from the briquette strand, a single lug is provided at the feeder that cuts through the center web of the struck-off briquette row.

A comparable system is described in of DE 35 07 166, where the roller press has two counter rotating briquetting rollers that work together and that have outer surfaces formed with cavities that form the briquettes and produce a two-column briquette strand whose briquettes are connected to each other by webs and that are separated by a crusher such that both the webs running transversely to the strand longitudinal direction and also the longitudinal webs are crushed. The crusher has in turn a rotor with a plurality of retaining plates mounted on its outer surface and that move radially and have a recess in the center. During rotation of the crusher rotor, the retaining plates pass a crusher lug where the briquette strand sliding down the chute after leaving the front edge of the chute is still supported in the middle. As a result the briquette strand lies with the break edges running transversely to the strand longitudinal direction on the front edge of the chute and the retaining plates hit the individual briquettes. The briquette strand breaks at these breaking edges and in this way the individual briquettes are produced.

The same applies the plant of DE 25 14 703 where the briquette strand also has two columns next to each other, so that each individual briquette row consists of two briquettes that are separated via a single crusher lug.

Systems for briquetting and in particular for hot briquetting, in which a briquette strand is divided into individual briquettes with a separating apparatus, are also known in various embodiments from EP 3,183,371, U.S. Pat. Nos. 6,352,573, 5,731,272, 6,340,378 and EP 3,760,749 and WO 2008/078936.

EP 2,930,452 furthermore describes an apparatus for separating particles of a plate-shaped HBI strand, which has two rollers acting together.

Other embodiments of crushers or crushing apparatuses for briquetting are described in U.S. Pat. No. 3,300,815 and of DE 2,200,255.

The known plants for briquetting and in particular for hot briquetting rung are, as mentioned, as a rule equipped with briquetting presses in which a briquette strand is made with two briquette columns next to each other, i.e. formed by cavities on the outer surfaces of the rollers as two side by side circumferential rows of cavities on the roller surface. Making briquettes with such systems has proven itself in practice outstanding, since in particular perfect separation with the splitters described above succeeds, e.g. a beater drum interacts with an impact edge of the feed chute and a single lug.

In practice however there is the need to increase the production capacities and consequently the briquetting and in particular to optimize hot briquetting with respect to economic aspects. Here lies the invention.

The object of the invention is to provide an apparatus for subdividing a briquette strand and consequently a briquette separator of the type described above to economically make briquettes with simple construction and trouble-free operation.

For attaining this object the invention is a generic apparatus of the type described above where the beater assembly and the feeder for subdividing a briquette strand with briquette rows each have at least three briquettes next to one another, the beater has at least three beater teeth next to one another, the feeder has at least two lugs next to one another, and of the (several) lugs next to one another of the feeder at least one of the lugs is formed in such a way and/or oriented such that between this lug and the (directly) adjacent lug a spacing is formed that widens in the working direction and through which the divided briquettes are discharged.

The invention is based on the discovery that the economic efficiency of a plant for briquetting can be increased, if with a briquetting press a briquette strand is produced, that has not only two adjacent briquette columns, but more than two briquette columns, i.e. at least three and preferably at least four briquette columns. The plant capacity is therefore not simply increased in that more briquetting presses are used as is conventional, e.g. a briquette strand with two briquette columns, but by using briquetting presses with higher capacity, namely with at least three briquette columns, e.g. at least four briquette columns. From this consideration the briquette separator, i.e. the apparatus for separating the briquette strand, is set up such that perfect separation of a briquette strand takes place whose briquette rows each have at least three briquettes next to each other. For this both the beater and the feeder are optimized, because in the preferred embodiment the beater has at least three beater teeth next to each other and the feeder has e. g. at or below the impact edge two or also more lugs for the striking off the individual briquette rows that according to the invention each consist of at least three briquettes with two webs provided between the briquettes, or with e.g. at least for example four briquettes with three (longitudinal) webs formed between the briquettes.

The beater assembly is preferably (in a manner known in principle) a rotationally driven beater drum or has such a rotationally driven beater drum. According to the invention, the beater drum has a plurality of rows distributed over its outer surface that each have at least three beater teeth next to one another. Alternatively a beater can also be used that instead of a rotationally driven beater drum is e.g. a linearly movable beater element is provided with e. g. a single row of beater teeth and at least three beater teeth next to one another, and such a linearly operating beater element is e.g. periodically moved in a straight line back and forth and is moved, e.g. is lowered and raised. However, instead of the linearly movable system, the rotationally driven beater drum is preferred.

Of particular importance in the context of the invention is the increased number of teeth of the beater assembly and the increased number of lugs and consequently protrusions below the impact edge of the feeder. To this end the invention proposes in a preferred further development that the number n of beater teeth (in a row of beater teeth) of the beater assembly is one greater than the number m of lugs of the feeder, i. e. the number m of lugs at the feeder so n=m+1, where n∃3.

Alternatively or in addition the number n of teeth of the beater apparatus is equal to or smaller than the number b of briquettes in the briquette rows, i.e. n=b or n<b, and is with b∃3, i.e. n=b or n<b, and with b∃3, e.g. with b∃4. Preferably n=b.

Alternatively or in addition the number m of lugs of the feeder is smaller than the number b of briquettes in the briquette rows, i.e. m<b and indeed with b∃3, e.g. with b∃4, i.e. m<b and with b∃3, e.g. with b∃4.

In a variant of the invention the number n of teeth is equal to the number b of the briquettes and the number m of lugs is smaller by one than the number b of briquettes so n=b and m=b−1 and consequently m=n−1. With this variant, the number b of briquettes can be even or odd. In this variant, each briquette in a briquette row is always assigned a tooth, i.e. each briquette is hit by its own tooth. Furthermore, each material web between two adjacent briquettes of a briquette row is engaged by a lug, i.e. each material web of a briquette row (directly) engages a lug aligned with this material web during cutting.

It is always advantageous, if not only perfect separation of the briquettes is ensured, but also a perfect and trouble-free discharge of the separated briquettes. For this purpose in the embodiments according to the invention and particularly preferably, at least an inner tooth between outer beater teeth can pass between two (directly) adjacent lugs, so that in each case two neighboring lugs are traversed by a tooth. Thus perfect removal of the briquettes is ensured, and indeed in particular of the inner briquettes that are in a briquette row between outer briquettes. One or several inner briquettes fall after the separation consequently not only (passively) through the space between the lugs, but they are pushed by at least one tooth through the space.

A first embodiment is provided e.g. for subdividing a briquette strand with three briquette columns, i.e. with briquette rows that each have three briquettes next to each other. In this case the beater has three beater teeth and the feeder has two (transversely offset) lugs, and each beater is aligned with a respective briquette of a briquette row and each lug is aligned with a material web between two adjacent briquettes. In this first embodiment, the individual beater teeth consequently directly strike the individual briquettes and the lugs act directly on the webs between so that perfect separation takes place.

A second embodiment of the invention is provided, for example, for subdividing a briquette strand with four briquette columns, i.e. with briquette rows that each have four briquettes next to each other. The beater has four beater teeth and the feeder has three (transversely offset) lugs, and each beater is associated with a briquette of a briquette row and each lug is associated with a material web between two adjacent briquettes. Also in this second embodiment the individual beater teeth, as in the first embodiment, consequently directly strike the individual briquettes and the lugs act directly on the briquette webs therebetween, so that perfect separation takes place. The lugs are each transversely offset to the beater teeth, that is perpendicular to the working direction.

The invention can be realized also with briquette strands with more than four briquette columns, where the individual briquette rows consequently have more than four briquettes next to each other and where the number of briquettes in a briquette row can be even or odd.

Of particular importance for flawless and economical operation of the system is in addition to the fast and functionally reliable cutting also the flawless discharge of the separated briquettes from the area of the beater. In particular disturbances due to jamming or blockages in the area of the beating cleaning apparatus should be avoided. For this purpose it is proposed that of the at least two lugs of the feeder next to each other at least one of the lugs is formed in such a way and/or is oriented such that a space between this lug and the lug directly next to it widens in the working direction and serves for discharging the separated briquettes. This can be realized e.g. in that at least one of the lugs is oriented at an angle and/or has a thickness tapering in the working direction. Preferably at least two lugs are obliquely oriented and/or at least two lugs have a thickness that tapers in the working direction. Here it can be e.g. two lugs directly next to each other. In a row of briquettes with (only) three briquettes next to each other preferably (only) two lugs next to each other are provided that are oriented e. g. in opposite directions at an angle to each other and form, for example, a funnel-shaped widening space. As an alternative to an oblique orientation of a lug, the invention also comprises a curved or curved orientation or configuration. Thus, if there are only two lugs, these can be curved in opposite directions to form a space widening in the working direction. In an embodiment with e.g. three lugs it is proposed that of the several lugs of the feeder next to each other the two outer lugs are formed in such a way and/or are oriented in such a way that the space between each outer lug and the adjacent inner lug widens in the working direction for passage of the separated briquettes. This can be realized e.g. in that the outer lugs are each obliquely oriented (or curved) and/or have a thickness tapering in the working direction. An oblique orientation (or curved shape) and/or a tapering thickness in the working direction can consequently increase the spacing between the lugs, so that a (e.g. funnel-shaped) widening space is created for discharge of the individual briquettes in the working direction.

Further advantages are achieved by a preferred positioning of the lugs in the working direction. Thus optionally, of the several adjacent lugs, one or several (e.g. adjacent) lugs is/are offset in the working direction. Thus there is (in particular with at least three lugs) the possibility that an inner, e.g. central, lug is offset opposite from the outer lugs in the working direction upstream or downstream. Thus lugs can be such that when the beater teeth next to each other hit the briquette strand first two forward outer lugs separate the two outer briquettes and the downstream back lug then separate the two middle briquettes. This also prevents malfunctions caused by jamming or clogging caused by the briquettes. Consequently in this embodiment the central or middle lug is spaced a predetermined dimension below the two outer lugs. In an alternative embodiment, the central lug can also be upstream, so that on impact of the teeth next to each other engage and split the central web is split and thereafter the two outer webs are split.

In one embodiment, the middle lug is dispensed with and there are only two provided (outer) lugs preferably at the same level.

The special arrangement of the lugs and in particular an inclined arrangement and/or an offset arrangement is in particular particularly advantageous for embodiments in which each web is assigned a lug, so that the spacing between all lugs is relatively small.

Alternatively or in addition to the inclined and/or offset positioning of one or several lugs, the removal of the briquettes can be ensured by or improved when during operation two adjacent lugs are passed by a beater tooth. The apparatus is therefore designed in such a way, that at least an inner beater tooth between outer beater teeth passes between (directly) adjacent lugs during operation.

The invention relates moreover not only to the described splitter or the described separator, but also a plant for making briquettes that is equipped with a such separator. The plant has at least a briquetting press, in particular a hot briquetting press, with which at least a briquette strand of the above-described type is continuously produced with briquette rows containing at least three, e.g. three or four briquettes, briquettes (or even more than four briquettes) next to each other in the briquette rows. Furthermore, the system has downstream of the briquette press, e.g. below the briquette presses, a splitter of the above-described type that serves to cut the briquette strand emerging from the briquetting press. The essential to the invention splitter is consequently also a component of a briquetting plant and consequently in combination with a respective briquetting press within the scope of the invention.

Preferably the invention concerns the briquetting of hot material and consequently hot briquetting. Particularly preferably the invention relates to the hot briquetting of directly reduced iron and consequently the production of HBI (hot briquetted iron). The invention can be used also for briquetting or subdividing a briquette strand from other material.

In the following the invention is explained in more detail with reference to a drawing that however shows embodiments. Therein:

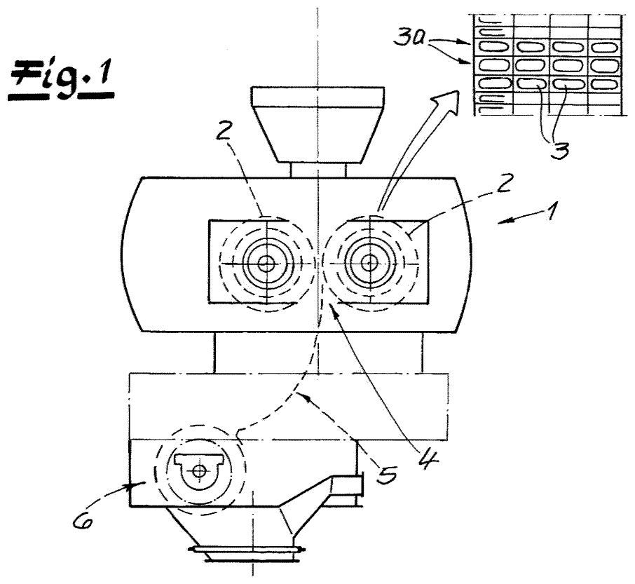

FIG. 1 is a simplified side view of a system for making briquettes;

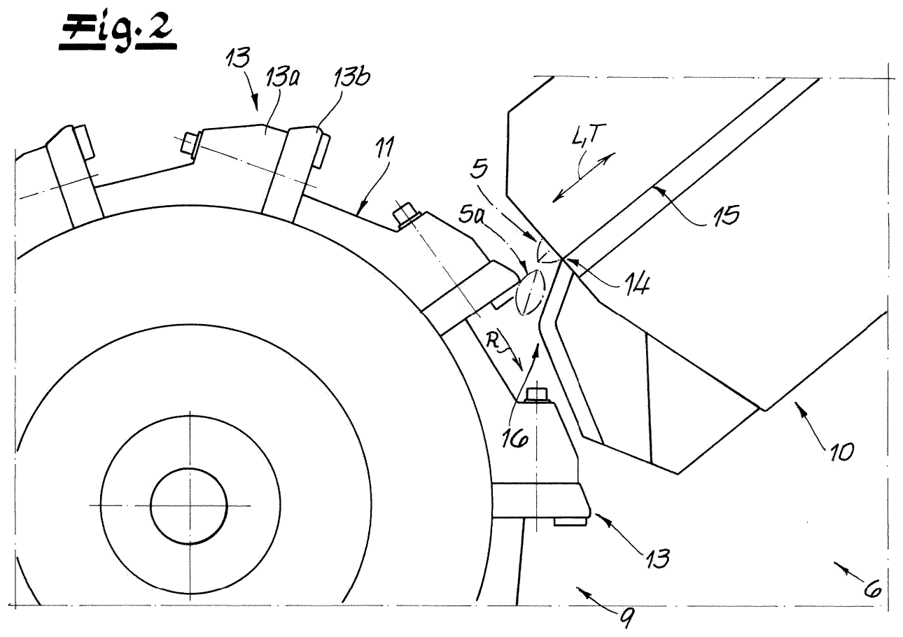

FIG. 2 shows an apparatus for separating the briquettes with the system of FIG. 1;

FIG. 3 is a side view of the outer surface of beater drum of a first embodiment of the apparatus of FIG. 2;

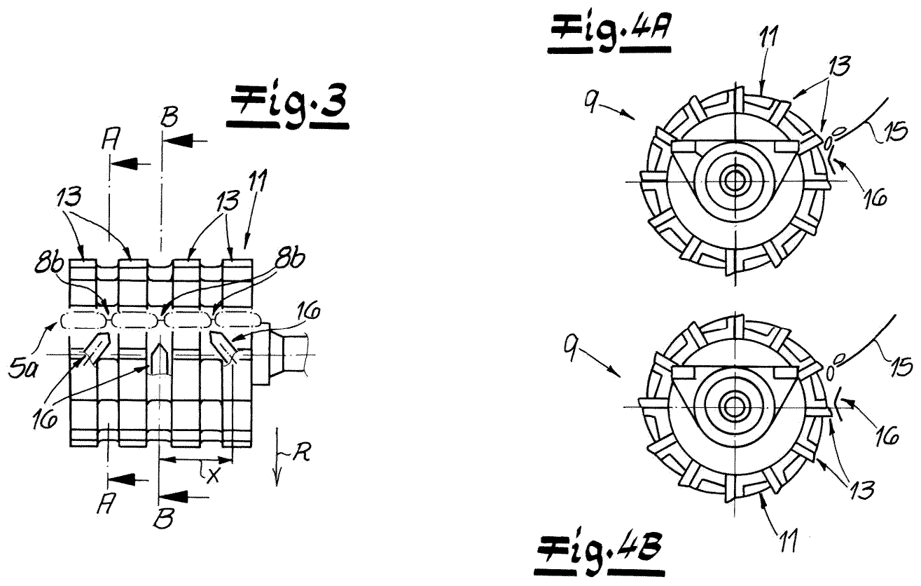

FIG. 4A is cross section A-A through the beater of FIG. 3;

FIG. 4B is cross section B-B through the beater of FIG. 3;

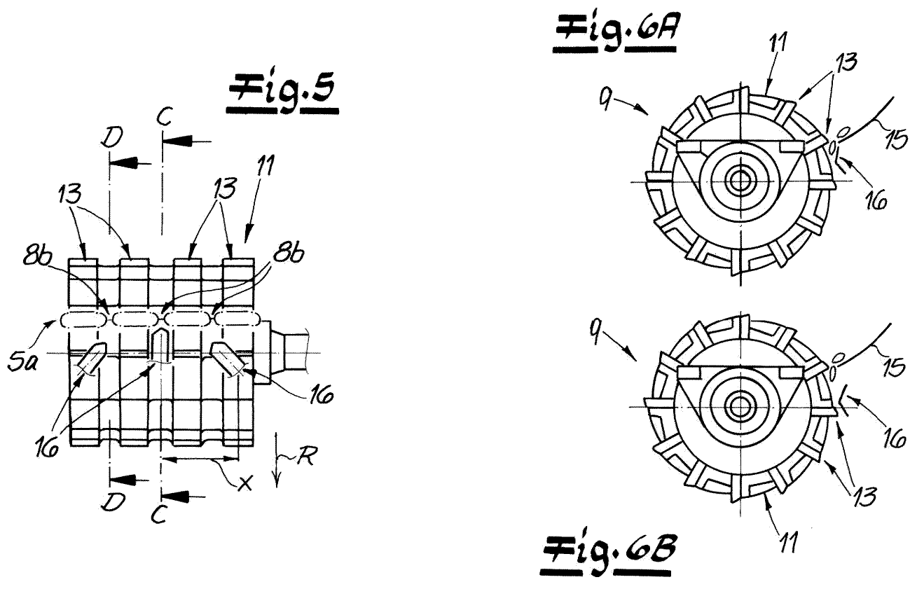

FIG. 5 shows a second embodiment of the invention;

FIG. 6A is cross section C-C through the embodiment of FIG. 5;

FIG. 6B is cross section D-D through the embodiment of FIG. 5;

FIG. 7 shows a third embodiment of the invention; and

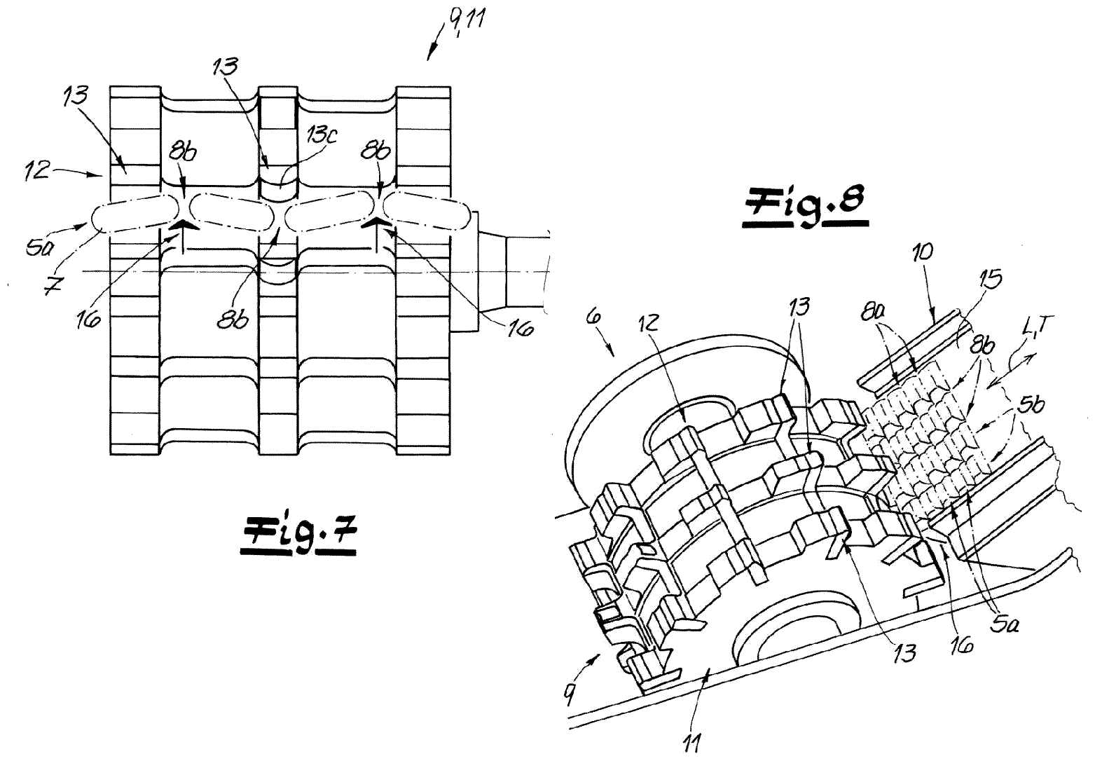

FIG. 8 is a perspective view from above of the third embodiment of FIG. 7.

FIG. 1 shows a plant for briquetting and consequently is a plant for making briquettes that in particular is intended for hot briquetting. This plant has a briquetting press 1 that is equipped with two counter-rotating briquetting rollers 2, and the surfaces of the briquetting rollers 2 are provided with cavities 3 for forming briquettes. A briquette strand 5 emerges continuously from a roller gap 4 of the briquetting press and is then subdivided by a downstream splitter 6, i.e. the briquette strand is subdivided into individual briquettes 7. This splitter 6 is a component of the plant shown in FIG. 1 and is shown in the FIGS. 2 to 9 in detail.

The briquetting press 1 is designed within the framework of the invention for making a briquette strand 5 with briquette rows 5a one after the other in the longitudinal direction L and each having at least three, preferably at least four, briquettes 7 next to one another. For this purpose the rollers 2 of the briquette press 1 are formed on their outer surfaces with a plurality of rows 3a of cavities 3 and each row 3a in this embodiment has four mold cavities 3, so that the briquette strand 5 shown in FIG. 8 is produced that consists of four briquette columns 5b extending in the longitudinal direction L and a plurality of transverse briquette row 5a spaced in the longitudinal direction L one after the other each with four briquettes 7 next to one another, and the briquette rows one after the other are separated by transverse webs 8a, i.e. by webs extending transversely with the briquettes 7 of an individual briquette row 5a next to one another and consequently also the briquette columns 5b of the strand 5 are connected by longitudinal webs 8b.

The splitter 6 separating the briquette strand 5 consists in this embodiment of on the one hand a movable beater assembly 9 and on the other hand a feeder 10 that advances the briquette strand 5 in a transport direction T into the area of the beater assembly 9 (cf. e.g. FIG. 2). The assembly 9 is in this embodiment equipped with a rotatably driven beater drum 11 that has an outer surface provided with a plurality of rows 12 each carrying a plurality of beater teeth 13. This rotating beater drum 11 strikes with the beater teeth 13 in such a way onto the briquette strand 5 supplied to it that on the one hand a briquette row 5a is knocked off the briquette strand 5 and on the other hand the briquette row 5a is subdivided into the individual briquettes 7. According to the invention the beater assembly 9 on the one hand and/or the feeder 10 on the other hand supplies a briquette strand 5 with four longitudinal rows 5b of briquettes next to each other and also with transverse rows 5a of briquettes one after the other, which each have at least four briquettes 7 next to one another. In this illustrated embodiment, both the beater assembly 9 (i.e. the beater drum 11) and also the feeder 10 are adapted to the shape of the briquette strand 5 with the four briquettes next to each other 7. For this purpose, the beater assembly 9 or the beater drum 11 has at least three beater teeth 13 next to each other. In the illustrated embodiments, either three or four adjacent beater teeth 13 are provided. This will be discussed in detail further. The feeder 10 has in a fundamentally known manner an impact edge 14 at its output end for knocking off the briquette rows 5a. The feeder is or has a material chute 15. Furthermore, the feeder 10 can have an unillustrated hold-down apparatus, that presses the briquette strand 5 down onto the chute 15 in order to prevent deviation or doubling up. The end of the material chute 15 forms the impact edge 14 at which the briquette rows 5a are knocked off by the rotating beater drum 11, so that as it were briquette groups are separated as the briquette rows 5a. According to the invention, in the area of the subdividing edge 14 or below this edge 14 a plurality of lugs 16 or projections are provided such that in the course of hitting with the beater teeth 13 on the separated briquette row 5a this briquette row 5a is broken in turn into individual briquettes 7. Due to the effect of the beater teeth 13 on the end of the briquette strand 5, consequently at the impact edge 14 the transverse webs 8a between the briquette rows 5a are cut and at the lugs 16 the longitudinal webs 8b between the individual briquettes 7 of a briquette row 5a are in turn cut.

In the embodiments shown, the number n of beater teeth 13 at the beater assembly 9 is greater by one than the number m of lugs 16 on the corresponding feeder 10, i.e. n=m+1, in the illustrated embodiments n=3 or n=4.

In the embodiments shown, the number n of beater teeth 13 of the beater assembly 9 is equal to the number b of briquettes 7 in the individual briquette rows 5a, i.e. n=b. The number m of the lugs 16 on the feeder 10 is smaller by one than the number b of the briquettes 7 in the briquette rows 5a, i.e. m=b−1. Thus b∃3 or b∃4. The FIGS. 3 to 6B show embodiments with b=4 and accordingly m=3. FIGS. 7 and 8 show an embodiment with b=3 and accordingly m=2. b can therefore be even or odd. A separate tooth 13 is always (preferably) aligned with each briquette of a briquette row and a separate lug 16 is aligned with each material web 8b between two adjacent briquettes of a briquette row.

Starting from these general dimensional considerations, FIGS. 3, 4A, 4B on the one hand and FIGS. 5, 6A and 6B on the other hand show two embodiments in which the beater assembly 9 has a plurality of rows 12 each having four beater teeth 13, while the feeder 10 has three lugs 16 next to one another. In these embodiments each tooth 13 of a row 12 of beater teeth 13 is associated with a briquette 7 of a row 5a of briquettes. Each individual lug 16 is aligned with a material web, namely a longitudinal web 8b within a briquette row 5a and between two adjacent briquettes 7 within a transverse briquette row 5a. Thus these figures show that in the course of rotation the beater drum 11 strikes with a row 12 of four beater teeth 13 next to each other on a row 5a of four briquettes 7, and presses them against the three lugs 16 below the striking edge 14, so that the 5a row of briquettes is separated. The same applies to the embodiment according to FIGS. 5, 6A and 6B.

The embodiments according to FIG. 3 (or 4A, 4B) on the one hand and FIG. 5 (or FIGS. 6A and 6B on the other hand) differ by the positioning of the three lugs 16 in the working direction R. For this reference is made to a comparative consideration of these figures. It is recognizable that in the embodiment according to FIG. 3 (or 4A, 4B) the two outer lugs 16 are positioned downstream of the central, inner lug 16 in the working direction R and the inner lug 16 is upstream in the working direction by a predetermined dimension of the outer lugs 16. This is also recognizable in a comparative view of FIGS. 4A and 4B, and in FIG. 4A one of the outer lugs and in FIG. 4B the central lug is downstream in comparison.

In contrast, in the embodiment according to FIG. 5 (or 6A, 6B) the outer lugs 16 are downstream relative to the inner lug 16, i.e. the middle lug is positioned upstream of the outer lugs and consequently higher. This results in turn from a comparative view of the FIGS. 6A and 6B, where FIG. 6A in turn shows one of the outer lugs and FIG. 6B the middle lug.

In the embodiments according to FIGS. 3, 5, 6A, and 6B a special alignment of the outer lugs 16 is provided, because these outer lugs 16 or their inner guide surfaces are oriented at an angle, so that between the outer lugs 16 and the inner lug 16 there is a spacing X that expands in the working direction R and through which the separated briquettes 7 are discharged. In particular combining this inclined position on the one hand and the offset arrangement on the other hand between the lugs 16 forms a sufficient intermediate space for perfect discharge of the individual briquettes 7, without jamming or blockages occurring that lead to shutting down the system. The lugs 16 themselves can be inclined (or bent/curved) or they each can have (inner) inclined (or bent/curved) guide surfaces that can be realized, for example, by the lugs 16 themselves having an unequal thickness and tapering in the working or transport direction.

FIGS. 7 and 8 show a further, particularly preferred embodiment of the invention that is comparable in its basic structure and function to the embodiments already described. This apparatus is designed for subdividing a briquette strand with briquette rows that each have three briquettes next to each other 7. The beater assembly 9 has three beater teeth 13 and the feeder 10 has two lugs 16, and each tooth 13 is aligned with a briquette 7 of a briquette row 5a and each lugs 16 is aligned with a material web 8b between two adjacent briquettes 7. Also in this embodiment the two lugs 16 are formed or oriented such that between these lugs 16 there is a spacing X that widens in the working direction R and through which the separated briquettes are discharged. There, an embodiment is shown in which the two lugs 16 are set at an angle in opposite directions so that the widening spacing X is formed. In this embodiment consequently also the already mentioned advantages described in connection with the other embodiments are achieved. Alternatively there is also the possibility that the lugs 16 are not completely inclined (or alternatively also bent/curved in opposite directions), but each have an inner, inclined or curved guide surface that for example can be formed in that the lugs themselves have an uneven thickness and taper in the transport or working direction.

As an alternative to the illustrated oblique orientation of the lugs, a curved or curved configuration of the lugs is also included. It is always important that the configuration and/or orientation of the lugs (or at least one lug) results in the widening spacing of for the briquettes in the transport direction.

Moreover, the figures show that in all embodiments the beater teeth 13 and the lugs 16 are realized such that at least an inner tooth between outer teeth can pass between two adjacent lugs during operation. Thus e.g. the embodiment according to FIGS. 3 and 5 ensures that the spaces between two adjacent lugs 16 are passed through by one of the inner beater teeth 13 between the two outer 13 teeth. The two inner briquettes 7 of a briquette row 8b pass consequently not only simply through the space between the central lug and the in each case the outer lug 16, but they are guided by the inner beater tooth 13 between the lugs. This improves the transportation of the briquettes and. The same applies for the embodiment according to FIG. 7, because also there the two adjacent lugs are traversed by a beater tooth.

In the case of a briquette strand with briquette rows that each have three briquettes next to one another and alternative to the embodiments according to the invention it is also conceivable in principle that an embodiment has only two beater teeth and two lugs, where the two beater teeth would be aligned with the two outer briquettes and the two lugs would be aligned with the two material webs. In one such embodiment, the middle briquette would fall between the two adjacent lugs without a tooth passing through the two adjacent lugs and pushes the middle briquette with it. Compared to such an embodiment with only two beater teeth, the embodiments according to the invention in particularly preferably with two adjacent lugs passed through by one beater preferably ensure improved removal of the briquettes.

The beater drum 11 is formed in a manner known in principle as rotor or beater rotor, and namely with the described rows 12 that each have three or four beater teeth 13. Each individual tooth 13 consists of a support bump 13a formed on the wheel 11 and a retaining plate 13b connected to the support 13a, so the retaining plates 13b is detachably attached to the supports 13a, e.g. by screws, so that the retaining plates 13b can be replaced as wear parts. This technology is known from the prior art. Within the scope of the invention, the lugs 16 can also be replaceable as wear parts.

It is within the scope within the scope of the invention, that the teeth 13 in a row 12 of teeth 13 and consequently also whose retaining plates 13b can have a different width. Thus there is the possibility that with only three teeth 13 the middle tooth 13 has a larger width or a smaller width than the two outer teeth 13.

In the figures, embodiments are always shown in which each briquette is assigned a tooth 13 and each web 8b between two briquettes is assigned a lug 16. However, the invention also includes embodiments not shown in which, in addition to the briquettes recognizable in the figures, further briquettes, beater teeth or lugs are provided that are designed in a modified embodiment and/or orientation. For example, additional areas can be provided in which a tooth 13 is not directly aligned with a briquette, but a tooth can also be aligned with a pair of briquettes, for example, in that the tooth works together on two briquettes next to each other and thus strikes the web or the separation point between two adjacent briquettes. In addition to the symmetrical arrangements of the apparatus shown in the figures, further beater teeth and/or further lugs can therefore also be provided in asymmetrical form that are not designed in the manner described.

At least one lug is always provided that is designed or oriented, e.g. inclined, in such a way that the risk of jamming for the briquette associated with the lug is reduced. In general, the idea of the invention can also be formulated as follows:

If (a) a briquette is assigned a tooth and (b) the two webs for this briquette are each assigned a lug and if, in addition, one of these two conditions (a) or (b) does not apply to at least one briquette adjacent the briquette, then the lug lying on this side is formed and/or oriented in the manner according to the invention and is consequently set at an angle, for example, so that the risk of jamming is reduced for this briquette.

1. In an apparatus for cutting a briquette strand that has a succession of longitudinally one after the other, contiguous briquette rows that each have next to one another a respective plurality of briquettes connected via material webs;
a movable beater assembly has a plurality of beater teeth next to one another;
a feeder supplies the briquette strand to the beater assembly in a transport direction,
the beater teeth of the beater assembly strike the briquette strand supplied by the feeder such that on the one hand a briquette row is struck off the briquette strand and on the other hand the struck-off briquette row is subdivided into individual briquettes,
the feeder has at an output end an impact edge for striking off a row of briquettes and below the impact edge lugs for separating the struck-off briquette row into individual briquettes,
the improvement wherein:
the beater assembly and the feeder are set up for subdividing a briquette strand with briquette rows that each have at least three briquettes next to one another,
that the beater assembly has at least three beater teeth next to one another and the feeder has at least two lugs spaced apart next to one another, and
of the lugs of the feeder at least one of the lugs is formed in such a way and/or is oriented such that a spacing is formed between this lug and the adjacent lug that widens in the working direction.

2. The apparatus according to claim 1, wherein at least one of the lugs is oriented obliquely or is curved and/or has a thickness that tapers in the working direction.

3. The apparatus according to claim 1, wherein at least two lugs directly next to one another are each obliquely oriented or curved and/or have a thickness that tapers in the working direction.

4. The apparatus according to claim 2, wherein the number (n) of the beater teeth on the beater assembly is one greater than the number (m) of the lugs on of the feeder, whereby n=m+1, with n≥3.

5. The apparatus according to claim 4, wherein
the number (n) of beater teeth of the beater assembly is equal to the number (b) of briquettes in the briquette, whereby n=b with b≥3 or with b≥4,
and/or
the number (m) of lugs of the feeder is smaller by one than the number (b) of briquettes in the briquette rows, whereby m=b−1 with b≥3, or with b≥4.

6. The apparatus according to claim 5, wherein each material web between two adjacent briquettes of a briquette row is aligned with a respective one of the lugs.

7. The apparatus according to claim 1, wherein the beater assembly is or has a rotationally driven beater drum and the drum has an outer surface carrying a plurality of tooth rows each with at least three adjacent teeth.

8. The apparatus according to claim 1, wherein at least an inner tooth between outer beater teeth can pass between two adjacent lugs.

9. The apparatus according to claim 1 wherein, for subdividing a briquette strand with briquette rows that each have three briquettes next to one another, the beater assembly has three beater teeth and the feeder has two lugs, each tooth being aligned with a respective briquette of a briquette row and each lug being between two adjacent briquettes and aligned with a respective material web.

10. The apparatus according to claim 1, wherein, for subdividing a briquette strand with briquette rows that each have four briquettes next to one another, the beater assembly has four beater teeth and the feeder has three lugs, each tooth being aligned with a respective briquette of a briquette row and each lug being aligned with a respective material web between two adjacent briquettes.

11. The apparatus according to claim 1, wherein of the lugs next to one another of the feeder, outer lugs are formed in such a way and/or are oriented in such a way that between each outer lug and the adjacent inner lug there is a space that widens in the working direction and through which the separated briquettes are discharged.

12. The apparatus according to claim 11, wherein the outer lugs are each oriented at an angle and/or have a thickness tapering in the working direction.

13. The apparatus according to claim 1, wherein one or several lugs of the lugs next to one another are offset relative to one or to other lugs in the working direction.

14. The apparatus according to claim 13, wherein of three lugs next to each other, an inner or central, lug is downstream or upstream in the working direction of the flanking outer lugs.

15. A system for making briquettes, the system comprising:
at least one briquetting press continuously producing at least a briquette strand, and
at least one apparatus according to claim 1 is provided downstream of the briquetting press for subdividing the briquette strand emerging from the briquetting press.
